(19) United States
(12) Patent Application Publication
(10) Pub. No.: US 2021/0239501 A1
(43) Pub. Date: Aug. 5, 2021

(54) MEASURING DEVICE AND MEASURING PROBE FOR A FLOWING FLUID

(71) Applicant: TECHNISCHE UNIVERSITÄT GRAZ, Graz (AT)

(72) Inventor: Mario THEISSL, Schwanberg (AT)

(73) Assignee: TECHNISCHE UNIVERSITÄT GRAZ, Graz (AT)

(21) Appl. No.: 17/269,327

(22) PCT Filed: Jul. 18, 2019
(86) PCT No.: PCT/EP2019/069315

§ 371 Date: Feb. 18, 2021

(30) Foreign Application Priority Data
Aug. 22, 2018 (EP) 18190129.9

(51) Int. Cl. G01F 1/696; G01F 1/688; G01F 15/02; G01F 1/66

(52) U.S. Cl. CPC G01F 1/696; G01F 1/661; G01F 15/022; G01F 1/6888

(57) ABSTRACT

The disclosed subject matter relates to a measuring device for measuring the flow velocity of a flowing fluid, comprising a first measuring element, which is configured to measure the flow velocity of the fluid and includes an interface that can be exposed to the flowing fluid, a second measuring element, which is configured to measure a characteristic property of the fluid and includes an interface that can be exposed to the flowing fluid, and an evaluation unit, which is connected to the first and second measuring elements and configured to correct the flow velocity, measured by the first measuring element, by the influence of the property of the fluid, measured by the second measuring element, on the measurement of the flow velocity. The disclosed subject matter furthermore relates to a measuring probe for such a measuring device.

The present invention relates to a measuring device comprising a measuring element for measuring the flow velocity of a flowing fluid. The invention furthermore relates to a measuring probe for such a measuring device.

The flowing fluid is a liquid or gaseous medium, such as air, water or oil, or a mixture of liquid and gaseous media. Measuring devices of the aforementioned type are used, for example, for flow measurement, such as in a flow duct of an oil-filled gear unit, or for measuring the wind speed in anemometry. In particular electromagnetic, differential pressure and ultrasonic methods as well as calorimetric methods are known for flow measurement.

In the latter method, a sensor, which, for example, has a temperature-dependent electrical resistance and is exposed to the flowing fluid, is heated. The fluid flowing past the thermally conductive interface of the sensor withdraws heat from the interface, and thus from the sensor. The withdrawn heat, which can be determined from the supplied heat and the temperature of the sensor, depends on the flow velocity of the fluid, so that the flow velocity can be inferred. In addition to the flow velocity, the withdrawn heat, however, also depends on the temperature difference between the interface and the fluid and on the mass density thereof. If the temperature of the fluid is not known, this can be determined with little additional effort, for example using another temperature sensor. Comparable relationships apply to the aforementioned other measuring methods, the electromagnetic, differential pressure and ultrasonic methods.

In many applications, for example when measuring the wind speed or the flow rate in a flow duct, the fluid to be measured (such as air, water or oil) with respect to the flow velocity thereof is known. As a result, the mass density thereof, if not already known anyhow, can be estimated with sufficient accuracy, and in this way an unambiguous measurement result can be achieved. If, in contrast, the mass density of the fluid is not known, the respective measurement of the flow velocity does not yield an unambiguous result since the measurement value for a fluid having high mass density and a low flow velocity can coincide with the measurement value for a fluid having low mass density and a high flow velocity. Such a case occurs, for example, when measuring the flow velocity of the fluids in a flow duct of a partially oil-filled gear unit, since it is not known at what point in time which fluid flows past the measuring element. In the past, it has been customary to subsequently manually correct equivocalities or ambiguities, however this is a complex process that is not very accurate.

It is the object of the invention to create a measuring device for measuring the flow velocity and a measuring probe therefor, which always supply unambiguous measurement results, even for different fluids.

According to a first aspect of the invention, the object is achieved by a measuring device for measuring the flow velocity of a flowing fluid, which is characterized by: a first measuring element, which is configured to measure the flow velocity of the fluid and includes an interface that can be exposed to the flowing fluid; a second measuring element, which is configured to measure a characteristic property of the fluid and includes an interface that can be exposed to the flowing fluid; and an evaluation unit, which is connected to the first and second measuring elements and configured to correct the flow velocity, measured by the first measuring element, by the influence of the property of the fluid, measured by the second measuring element, on the measurement of the flow velocity.

The invention is based on the finding that it is possible to determine the fluid with high accuracy by measuring a characteristic property of the fluid, that is, a physical property of the fluid itself, such as the optical density, fluorescence, relative permittivity or the ohmic resistance thereof. In this way, it is possible to unambiguously measure the flow velocity of several different fluids as a result of the combination of two measurements: The flowing fluids are distinguished based on the respective measured characteristic property, so that the measuring device, after calibration, supplies an unambiguous, fluid-specific measurement value for the flow velocity at any point in time. A complex manual subsequent correction is dispensed with. In the process, the measuring device is able to distinguish not only between fluids of different phases (liquid or gaseous), but also, based on the dissimilarity of the respective measured characteristic property of the fluid, between different oils, oils and water, or different gases, for example, and is even able to determine mixing ratios of the fluids.

An electromagnetic, differential pressure and/or ultrasonic method can be used, for example, for measuring the flow velocity of the fluid. The aforementioned interface of the first measuring element is preferably thermally conducting, and the aforementioned first measuring element is configured to calorimetrically measure the flow velocity of the fluid based on the heat transmission between the thermally conducting interface thereof and the flowing fluid. Such a measuring element for calorimetric measurement has a simple design and a robust and reliable operation.

Depending on the application and fluids that may be used, the second measuring element can, for example, measure the fluorescence, the relative permittivity or the ohmic resistance of the fluid. It is particularly advantageous, in contrast, when the aforementioned interface of the second measuring element is transparent, and the aforementioned second measuring element is configured to measure the optical density of the fluid based on the optical reflectivity or refractivity of the transparent interface thereof to the flowing liquid. Even minor differences in the optical densities of two fluids are sufficient to ensure that these can be unambiguously distinguished, for example as a result of the occurrence or non-occurrence of total reflection at the transparent interface. In this way, it is also possible, for example, to determine the gas content of the gear oil or the like, based on the optical density determined by the second measuring element, and the measurement of the flow velocity can be accordingly corrected. The case in which different fluids, due to identical refractive indices, would be indistinguishable is unlikely in practical applications.

In accordance with the so-called heating method, the calorimetric first measuring element could heat the fluid by way of an additional heating element arranged between the first and second temperature sensors, wherein the temperature difference of the flowing fluid is sensed upstream and downstream of the heating element. In a preferred embodiment, in contrast, the first measuring element comprises a first temperature sensor for the temperature of the fluid, and a second temperature sensor that is heated by a regulating circuit to a constant temperature difference compared to the temperature of the fluid and that includes the aforementioned thermally conducting interface, wherein the heating power supplied to the second temperature sensor by the regulating circuit is a measure of the flow velocity. In this process, the fluid is heated less than with the heating method, which not only saves energy, but also helps to avoid possible side effects in the flowing fluid. Furthermore, the measuring element can have a more space-saving design.

In a favorable variant, the aforementioned first temperature sensor is a first soldering joint, and the aforementioned second temperature sensor is a second soldering joint, of a thermocouple for measuring the temperature difference of the fluid between the first and second soldering joints. Thermocouples capture a temperature difference directly, so that a separate measurement of two temperatures, followed by a computation of the difference, is dispensed with, which simplifies the measuring device as a whole.

The optical second measuring element particularly preferably comprises a light source for emitting a light beam, a light guide, for the light beam, which includes the aforementioned transparent interface on which the emitted light beam impinges at an acute angle, a light sensor capturing a reflection or refraction of the light beam occurring at the transparent interface, and a detector circuit for the light sensor for detecting the optical reflectivity or refractivity of the transparent interface. This design of the second measuring element is simple and robust. Depending on the requirement, it is possible, on the one hand, to measure an angle of refraction of the light beam at the transparent interface based on the impingement point of the refracted light beam on the light sensor, and to thus determine the exact optical density of the fluid, for which purpose furthermore a possible portion of reflection of the light beam could be evaluated; as an alternative or in addition, the angle can be measured, at which total reflection of the impinging light beam occurs at the transparent interface, for example by the light source fanning out the light beam or emitting it in chronological sequence at differing angles at the transparent interface, and in the process also taking the local or temporal impingement of the reflected light beam on the light sensor into consideration. In most instances, on the other hand, it suffices to identify whether total reflection has occurred at the transparent interface, that is, whether the optical density of the fluid is sufficiently different, or not, from that of the light guide, so that two different fluids, one that is optically dense and another that is optically less dense, are distinguished in a simple manner.

It is advantageous when the evaluation unit is arranged in a housing, and, at the same time, the first and second temperature sensors, the light source, the light guide and the light sensor are arranged in a measuring probe that is separate from the housing. In this way, a flexibly usable, in particular sleek, measuring probe can be created, without having to integrate the overall measuring device and exposing it to the flowing fluid. Measuring data can be transmitted in the process via a cable, or a wireless link, from the measuring probe to the evaluation unit.

It is particularly favorable when furthermore the regulating circuit and the detector circuit are arranged in the housing. In this way, these parts of the measuring device are also not exposed to the temperature of the fluid, and the measuring probe is even smaller and more robust.

In a second aspect, the invention creates a measuring probe, which can be used in particular for a measuring device of the aforementioned type, comprising: a carrier; for measuring the flow velocity of the fluid, a first measuring transmitter, which is anchored at the carrier and includes an interface; for measuring a characteristic property of the fluid, a second measuring transmitter, which is anchored at the carrier and includes an interface; and an electrical connection to which the two measuring transmitters are connected, wherein the aforementioned interfaces of the first and second measuring transmitters are provided on an outer side of the measuring probe for immersion into a flowing fluid.

With respect to further variant embodiments of the measuring probe and the advantages of combining the measurement of the flow velocity with the measurement of a characteristic property of the flowing fluid for correcting the measurement of the flow velocity by the influence of the measured characteristic property, reference is made to the above comments regarding the measuring device. In particular, it is advantageous when the aforementioned first measuring transmitter comprises a first temperature sensor and a second temperature sensor including the aforementioned interface, wherein the aforementioned interface of the first measuring transmitter is thermally conducting, and/or, when the aforementioned second measuring transmitter comprises a light source for emitting a light beam, a light guide for the light beam including the aforementioned interface on which the emitted light beam impinges at an acute angle, and a light sensor capturing a reflection or refraction of the light beam occurring at the interface, wherein the aforementioned interface of the second measuring transmitter is transparent.

It is particularly favorable when, at the same time, the light source is anchored at a first side of the carrier, and the light sensor is anchored at a second side of the carrier facing away from the first side, and when the light guide extends from the first to the second side. In this way, the light source and the light sensor are optically separated from one another, without further components, so that disturbance by scattered light conducted via undesirable light paths is avoided.

The light guide particularly preferably has the shape of a prism, one lateral surface of which facing the light source and the light sensor, and at least one of the other lateral surfaces of which forming the aforementioned transparent interface. The second of the aforementioned other lateral surfaces may either be mirrored or likewise be transparent, and the two other lateral surfaces thus jointly form the transparent interface. In this way, a clearly detectable double reflection of the light beam at the aforementioned other lateral surfaces can be achieved, which facilitates the detection of the fluid based on the optical reflectivity or refractivity of the transparent interface. Furthermore, a prismatic light guide can be easily integrated into the measuring probe, for example at the tip thereof, in a manner that favors the flow.

In an advantageous embodiment, the light guide is made of silicone. Silicone is a soft material, which helps to avoid damage, for example to a flow duct, an oil-filled gear unit connected thereto, or the like, in the event the light guide detaches from the measuring probe.

It is furthermore favorable when the carrier is a flexible printed circuit board. Such a printed circuit board carries the required components, connects them in an electrically conducting manner, and can be brought into a desired shape, so that the measuring probe can be adapted to different applications, while otherwise keeping the design identical. At the same time, a region of the carrier, for example the region on which the second measuring transmitter is arranged, can be also curved or bent after having been applied to the carrier, so as to achieve a desired orientation of the measuring transmitter.

The invention will be described in greater detail hereafter based on an exemplary embodiment, which is shown in the accompanying drawings. In the drawings:

FIG. 1 shows a measuring device according to the invention in a schematic side view;

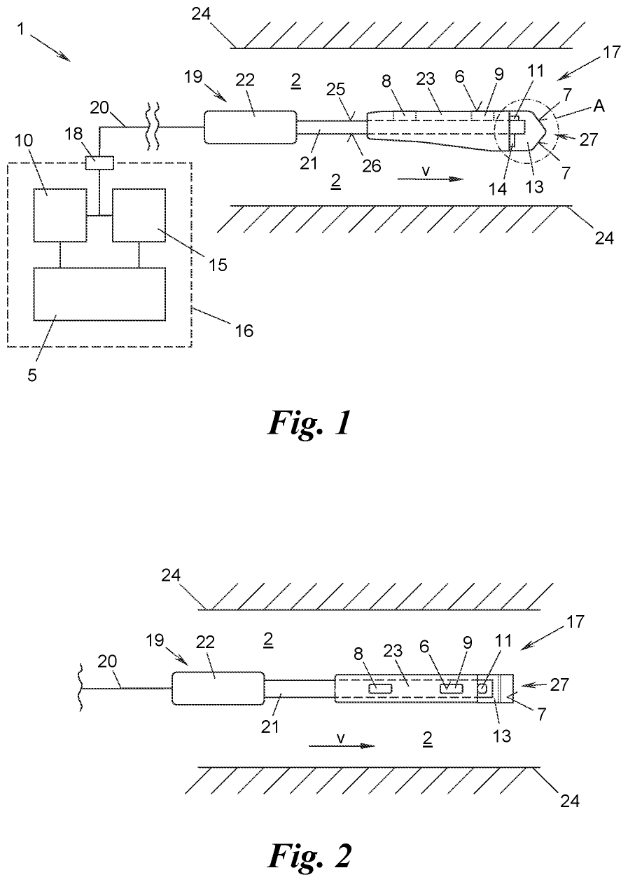

FIG. 2 shows the measuring probe of the measuring device of FIG. 1 in a schematic top view;

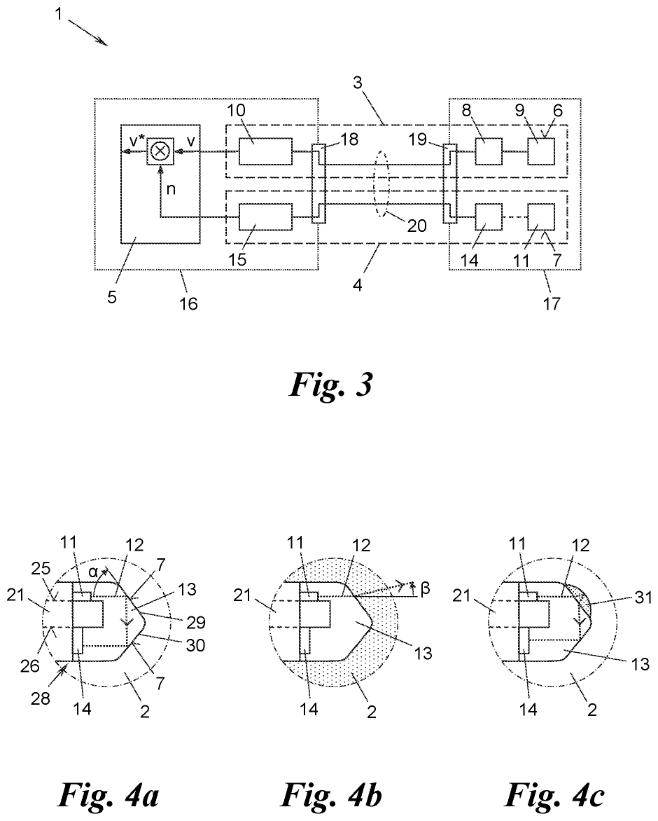

FIG. 3 shows the measuring device of FIG. 1 in a block diagram;

FIGS. 4a to 4c each show an enlarged detail A of the measuring probe of the measuring device of FIG. 1, immersed into a fluid having low optical density (FIG. 4a), into a fluid having high optical density (FIG. 4b), and into a fluid having low optical density, comprising a droplet of a fluid having high optical density which adheres to the measuring probe (FIG. 4c); and

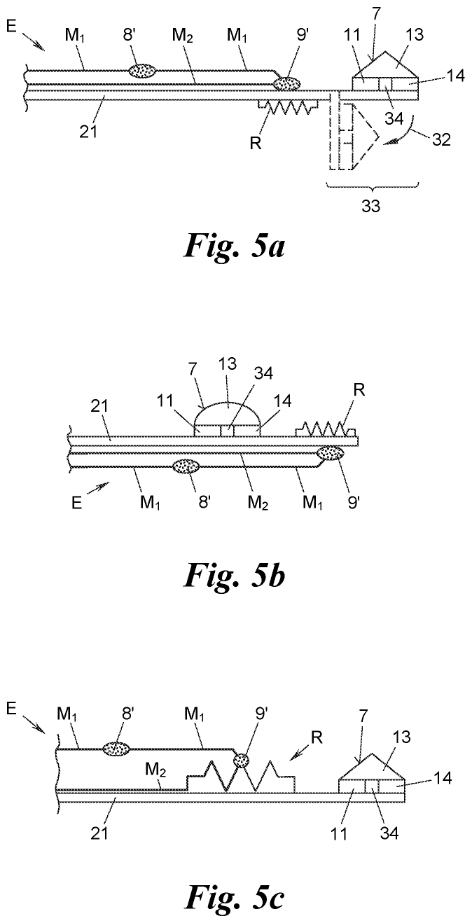

FIGS. 5a to 5c show variants of the measuring probe of the measuring device of FIG. 1, in each case in sections in schematic side views.

FIGS. 1 to 4 show a measuring device 1 for measuring the flow velocity v of a flowing fluid 2. The measuring device 1 comprises a first measuring element 3 and a second measuring element 4 (dashed lines in FIG. 3), and an evaluation unit 5. The evaluation unit 5 is connected to the first and second measuring elements 3, 4.

The first measuring element 3 calorimetrically measures the flow velocity v of the fluid 2 in the shown example. For this purpose, the first measuring element 3 captures the heat transmission between a thermally conducting interface 6 of the first measuring element 3 which is exposed to the flowing fluid 2 and the flowing fluid 2. The higher the flow velocity v and mass density of the flowing fluid 2, the higher is the heat transmission. A fluid 2 having a high flow velocity v and low mass density, for example, results in the same heat transmission as a fluid 2 having a low flow velocity v and high mass density.

As an alternative, the first measuring element 3 can determine the flow velocity v of the fluid 2 electromagnetically, by way of differential pressure measurement or ultrasonic measurement, for which purpose the aforementioned interface would, for example, be an electrode or a membrane or the like, as is known to a person skilled in the art. These alternative measurement methods also in each case result in ambiguity or equivocality during the measurement of the flow velocity v.

In the shown example, the second measuring element 4 measures the optical density n of the flowing fluid 2 so as to distinguish different fluids 2 from one another. For this purpose, the second measuring element 4 captures the optical reflectivity or refractivity of a transparent interface 7 located between the second measuring element 4 and the flowing fluid 2 and exposed to the flowing fluid 2. Instead of the optical density n, the second measuring element 4 could measure a different characteristic property of the fluid 2, that is, a different physical property of the fluid 2 itself, not a property that is impressed from the outside, such as the temperature, the pressure or the flow velocity v. For example, the second measuring element 4 could, for example, carry out an optical measurement of the fluorescence, a capacitive measurement of the relative permittivity, or a measurement of the ohmic resistance of the fluid 2; to do so, the aforementioned interface of the second measuring element 4 would, for example, be transparent again or would include one or more electrodes that are electrically insulated from one another. Especially in the case of compressible fluids 2, and in particular gases, the second measuring element 4, or a further measuring element, optionally additionally measures the pressure of the fluid 2, so that a pressure dependence on the heat conduction or heat dissipation of the fluid 2, and consequently of the heat transmission, can be compensated for more easily.

The evaluation unit 5 corrects the flow velocity v measured by the first measuring element 3 by the influence of the property (here: the optical density n), measured by the second measuring element 4, on the measurement of the flow velocity v (here: on the heat transmission at the thermally conducting interface 6), so as to obtain a corrected value v* of the flow velocity v. For this purpose, the evaluation unit 5 takes advantage of the fact that fluids 2 of differing mass densities, for example a gas and a liquid or water and an oil, and the like, in general have differing optical densities n, fluorescences, relative permittivities and/or ohmic resistances. Each of these properties of the fluid 2 is thus related to, for example, the heat transmission at the thermally conducting interface 6. When the fluid 2 has been identified based on the characteristic property thereof, it is possible to unambiguously measure the flow velocity v thereof, that is, an ambiguously or equivocally measured flow velocity v is corrected based on the measured property (for example the optical density n).

In the exemplary embodiment of FIGS. 1 to 3, the calorimetric first measuring element 3 comprises a first temperature sensor 8, for example a temperature-dependent electrical resistor, in particular a positive temperature coefficient (PTC) thermistor or a negative temperature coefficient (NTC) thermistor, a Zener diode or a thermocouple. By way of the first temperature sensor 8, the first measuring element 3 measures the temperature of the fluid 2 in the manner known to a person skilled in the art. The first measuring element 3 furthermore comprises a second temperature sensor 9, which comprises the aforementioned thermally conducting interface 6 to the flowing fluid 2. The first temperature sensor 8 optionally also includes a similar interface.

In this example, the second temperature sensor 9 is heated by a regulating circuit 10 so as to exceed the temperature of the fluid 2 measured by the first temperature sensor 8 by a constant temperature difference. The heating power supplied by the regulating circuit to the second temperature sensor 9 for this purpose is a measure of the flow velocity v of the fluid 2 due to the flow velocity-dependent heat transmission at the thermally conducting interface 6. For estimating and compensating for the dynamic behavior or the thermal inertia of the two temperature sensors 8, 9 during transient changes in the temperature or the flow velocity of the fluid 2, the evaluation unit 5 can furthermore comprise an optional estimator, for example a non-linear Kalman filter, a point estimator, or another estimator known in stochastic signal processing.

The second temperature sensor 9 is, for example, a temperature-dependent electrical resistor and is electrically heated directly by the regulating circuit 10; as an alternative, a separate heating resistor could be provided for this purpose.

In the embodiment according to FIGS. 5a to 5c, the first temperature sensor 8 is a first soldering joint 8′, and the second temperature sensor 9 is a second soldering joint 9′ of a thermocouple E. The thermocouple E comprises a pair of different metallic conductors M₁, M₂, which are connected to one another at the second soldering joint 9′, and measures the temperature difference between the first and second soldering joints 8′, 9′ directly, that is, without determining the respective temperatures. Metallic conductors M₁, M₂ that may be used include, for example, copper as the first conductor M₁, and a copper-nickel alloy, for example Constantan, as the second conductor M₂, as a “type T” thermocouple, or another pair of metallic conductors M₁, M₂ known in the prior art. At least one of the two metallic conductors M₁ or M₂ can, for example, be sputtered on by way of cathode sputtering, in particular when the other (for example copper) is provided anyhow as a conductor of the first measuring element 3. The second soldering joint 9′ is, as described above, heated by the regulating circuit 10 to a constant temperature difference by way of an electrical resistor. The electrical resistor can be designed as a separate heating resistor R (FIGS. 5a and 5b); as an alternative, the electrical resistor R is at least partially formed by the metallic conductors M₁ and/or M₂, so that the second soldering joint 9′ is formed directly at the electrical resistor R (FIG. 5c).

The regulating circuit 10 could also heat the second temperature sensor 9 using constant current, instead of heating it to a constant temperature difference compared to the fluid 2, and measure the temperature of the second temperature sensor 9 so as to determine the heat transmission at the thermally conducting interface 6 therefrom. Furthermore, the first temperature sensor 8 could be dispensed with, for example when the temperature of the fluid 2 is known with sufficient accuracy. In another alternative, a separate heating element (not shown) could be arranged upstream of the second temperature sensor 9 in the direction of the flow velocity v, so that the first and second temperature sensors 9 measure the temperature difference of the fluid 2 upstream and downstream of the heating element.

In the shown example, the optical second measuring element 4 comprises a light source (for example a light-emitting or laser diode) 11, which emits a light beam 12 (FIG. 4a). The second measuring element 4 furthermore comprises a light guide 13 for the light beam 12. The light guide 13 includes the aforementioned transparent interface 7. The light source 11 and the transparent interface 7 are arranged or oriented in such a way that the light beam 12 emitted by the light source 11 impinges on the interface 7 at an acute angle α.

Moreover, the second measuring element 4 comprises a light sensor (for example a photodiode) 14 and a detector circuit 15. The light sensor 14 is arranged and oriented so as to capture a reflection or a refraction of the light beam 12 at the transparent interface 7. The detector circuit 15 identifies a reflection or refraction, for example, based on a signal of the light sensor 14 exceeding or dropping below a threshold, and is able to infer therefrom a fluid 2 having lower or higher optical density n. Optionally, the detector circuit 15 can ascertain an angle α, at which total reflection occurs (FIG. 4a), or a refraction angle β (FIG. 4b), based on the impingement point of the light beam 12 on the light sensor 14, and determine therefrom the optical density n of the fluid 2, as is described in detail further down with reference to the illustrations in FIGS. 4a to 4c.

The light source 11 can be operated in a pulsed manner for optional compensation of ambient light, so that the detector circuit 15 or the evaluation unit 5 can correct the light beam 12, captured by the light sensor 14, by the ambient light captured by the light sensor 14 during pulse pauses. As an alternative or in addition, a filter can optionally be used so as to suppress ambient light deviating from the wavelength of the light beam 12.

The evaluation unit 5 of the measuring device 1 is arranged in a housing 16 in the example of FIGS. 1 and 3. Moreover, the first and second temperature sensors 8, 9 of the first measuring element 3 and the light source 11, the light guide 13 and the light sensor 14 of the second measuring element 4 are arranged in a measuring probe 17 that is separate from the housing 16. Furthermore, the regulating circuit 10 and the detector circuit 15 are arranged in the housing 16. The housing 16 and the measuring probe 17 each include an electrical connection 18, 19, wherein the regulating circuit 10 and the detector circuit 15 are each connected to the connection 18 of the housing 16, and the first and second temperature sensors 8, 9 and the light sensor 14, as well as optionally the light source 11, are connected to the connection 19 of the measuring probe 17. The connections 18, 19 are electrically connected to one another via a supply and data cable 20, so that the regulating circuit 10 is connected to the temperature sensors 8, 9, and the detector circuit 15 is connected to the light sensor 14, and optionally to the light source 11.

As an alternative, the regulating circuit 10 and the detector circuit 15 can be arranged in the measuring probe 17; furthermore, the evaluation unit 5 could even be arranged in the measuring probe 17, for example in the form of a microelectromechanical system (MEMS), if desired, and the housing 16 could be dispensed with. The cable 20 can optionally be replaced with a wireless data link and/or the measuring probe 17 can be supplied with energy by a battery, by inductive coupling, or by way of energy harvesting.

In the shown example, the measuring probe 17 comprises a carrier 21, for example an (optionally flexible) printed circuit board. A first measuring transmitter including an interface 6 is anchored at the carrier 21 for measuring the flow velocity v of the fluid 2; furthermore, a second measuring transmitter including an interface 7 is anchored at the carrier 21 for measuring a characteristic property of the fluid 2. In this example, the first measuring transmitter comprises the first temperature sensor 8 and the second temperature sensor 9, and the aforementioned interface is the thermally conducting interface 6; the second measuring transmitter comprises the light source 11, the light guide 13, which includes the transparent interface 7 as the interface of the second measuring transmitter, and the light sensor 14. The connection 19 is also optionally anchored at the carrier 21 and can be surrounded by a reinforcing sleeve 22. Optional thermal insulation 23, for example made of silicone, is attached to the carrier 21 around the second temperature sensor 9, and in particular between the first and second temperature sensors 8, 9. The thermal insulation 23, or another jacket, can enclose the carrier 21 at least in regions and impart a flow-favoring shape thereto at the same time.

It shall be understood that the (here: thermally conducting) interface 6 of the first measuring transmitter and the (here: transparent) interface 7 of the second measuring transmitter are exposed to the flowing fluid 2 at the outer side of the measuring probe 17, that is, without a casing, so that the two interfaces 6, 7 are exposed to the fluid 2 when the measuring probe 17 is immersed in the fluid 2. The measuring probe 17 can be immersed into a freely flowing fluid 2 or, as in the example of FIGS. 1 and 2, between walls 24 of a, for example, tubular flow duct, while the housing 16 is mounted outside the flowing fluid 2 and protected therefrom. If the cross-section of the flow duct is known, the mass flow of the fluid 2 can be determined from the flow velocity v in the known manner.

The light source 11 is optionally anchored at a first side 25 (in the present example: the top side) of the carrier 21, and the light sensor 14 is anchored at a second side 26 facing away from the first (here: the bottom side) of the carrier 21, so that the light source 11, from the view of the light sensor 14, is hidden by the carrier 21, whereby an interfering path of the light beam 12 leading past the transparent surface 7 to the light sensor 14 is prevented. Moreover, the light guide 13 extends from the first side 25 to the second side 26, for example at the tip 27 of the measuring probe 17. As an alternative, such an interfering light path could be suppressed by other components, as is described in more detail further down with reference to FIGS. 5a to 5c.

In the shown example, the light guide 13 has the shape of a prism, which with one lateral surface 28 thereof faces the light source 11 and the light sensor 14, and optionally extends at the first side 25 of the carrier 21 to the light source 11, and at the second side 26 of the carrier 21 to the light sensor 14 (FIG. 4a). At least one of the other lateral surfaces 29, 30 of the prism forms the aforementioned transparent interface 7; the second of the aforementioned other lateral surfaces 29, 30 could be mirrored, or both other lateral surfaces 29, 30 together could form the aforementioned transparent interface 7. As an alternative, a respective lateral surface 28, 29, 30 could face the light source 11 and the light sensor 14, and/or the light guides 13 could, for example, be parallelepiped or curved.

The light guides 13 are made of transparent glass or plastic material, for example epoxy, or of a soft transparent material, such as silicone or the like. The term “transparent” in this connection, as well as with respect to the transparent interface 7, denotes a condition to allow at least the wavelength or the wavelength range of the light beam 12 to easily pass through.

The examples of FIGS. 4a to 4c illustrate the function of the optical second measuring element 4. When the measuring probe 17 is immersed into a fluid 2 having low optical density n (FIG. 4a), the light beam 12 experiences total reflection, that is, reflection occurs, at the lateral surfaces 29, 30 of the prismatic light guide 13 which form the transparent interface 7, and is captured by the light sensor 14, which is detected by the detector circuit 15. When, on the other hand, the measuring probe 17 is immersed into a fluid 2 having high optical density n (FIG. 4b), the light beam 12 is not reflected at the transparent interface 7, but only refracted, that is, refraction occurs. The light sensor 14 then does not capture a reflected light beam 12, which is likewise detected by the detector circuit 15, in particular as absent reflection, and thus as refraction.

If the optical density n of the fluid 2 is to be determined more precisely, optionally either the light sensor 14 can be arranged at the side of the transparent interface 7 which is located opposite the light source 11 (not shown), so as to determine the refraction angle β, or the light source 11 can, e.g., fan out the light beam 12 in the illustration plane of FIG. 4a, so that the light beam 12 impinges on the transparent interface 7 at different acute angles α. The light sensor 14 could be divided into strip- or matrix-shaped fields, so that, based on the refraction or reflection captured by different fields of the light sensor 14, the angle of refraction β or the angle α at which total reflection occurs, and consequently the optical density n of the fluid 2, can be inferred. As an alternative, the light beam 12 could impinge on the transparent interface 7 at different angles α in chronological succession, for example in that the light source 11 deflects the light beam 12, thereby fanning it out, or in that the transparent interface 7 is pivoted, so that the optical density n of the fluid 2 can be determined based on the chronological capturing of a reflection by the light sensor 14.

As is shown in the example of FIG. 5b, the light guide 13 can, as an alternative to the prismatic shape, have a different shape, for example circular cylindrical including an interface 7 that has a convexly curved cross-section. It shall be understood that other curvatures of the interface 7 are possible, for example concave, wherein the light beam 12, even with little fanning, impinges on the transparent interface 7 at considerably different acute angles α, whereby the effect of the fanning is amplified.

FIG. 4c illustrates that the optical second measuring element 4 supplies correct measurement results even when, for example, a droplet 31 of a fluid 2 having high optical density n adheres to the transparent interface 7, even though the measuring probe 17 is immersed into a flowing fluid 2 having low optical density n. In this case, the light beam 12 is initially only refracted at the transparent interface 7 and enters the droplet 31, whereupon it is reflected at the outer surface thereof due to the lower optical density n of the surrounding fluid 2; thereafter, the reflected light beam 12, being refracted again, enters the light guide 13 again and continues to be reflected there toward the light sensor 14, similar to the example of FIG. 4a. The detection circuit 15 thus correctly detects the optical reflectivity of the transparent interface 7.

As is illustrated in FIG. 5a by the arrow 32, in the variant comprising a flexible printed circuit board as the carrier 21, a region of the carrier 21, for example an end region 33 carrying the second measuring transmitter, can also be curved or bent before or after the application of the measuring transmitter. In this way, the end region 33 of the carrier 21 is brought into the position shown with dotted lines in FIG. 5a, so as to, in this example, impart a desired orientation to the second measuring transmitter. It shall be understood that the carrier 21 can also be curved and/or bent (including multiple times) at another location.

In the examples of FIGS. 5a to 5c, an optional component 34 is furthermore arranged between the light source 11 and the light sensor 14. The component 34 does not allow the light beam 12 to pass, so as to cover the light source 11 from the view of the light sensor 14. In this way, possible disturbances by a path of the light beam 12, leading past the transparent surface 7, to the light sensor 14 are prevented.

The invention is not limited to the shown embodiments, but encompasses all variants, combinations and modifications that fall within the scope of the accompanying claims.

What is claimed is:

1. A measuring device for measuring the flow velocity of a flowing fluid, comprising:
a first measuring element, which is configured to measure the flow velocity of the fluid and includes an interface that can be exposed to the flowing fluid;
a second measuring element, which is configured to measure a characteristic property of the fluid and includes an interface that can be exposed to the flowing fluid; and
an evaluation unit, which is connected to the first and second measuring elements and configured to correct the flow velocity, measured by the first measuring element, by the influence of the property of the fluid, measured by the second measuring element, on the measurement of the flow velocity.

2. The measuring device according to claim 1, wherein the aforementioned interface of the first measuring element is thermally conducting, and the aforementioned first measuring element is configured to calorimetrically measure the flow velocity of the fluid based on the heat transmission between the thermally conducting interface of the first measuring element and the flowing fluid.

3. The measuring device according to claim 2, wherein the aforementioned first measuring element comprises a first temperature sensor for the temperature of the fluid, and a second temperature sensor that is heated by a regulating circuit to a constant temperature difference compared to the temperature of the fluid and that includes the aforementioned thermally conducting interface, the heating power supplied to the second temperature sensor by the regulating circuit being a measure of the flow velocity.

4. The measuring device according to claim 3, wherein the aforementioned first temperature sensor is a first soldering joint, and the aforementioned second temperature sensor is a second soldering joint, of a thermocouple for measuring the temperature difference of the fluid between the first and second soldering joints.

5. The measuring device according to claim 1, wherein the aforementioned interface of the second measuring element is transparent, and the aforementioned second measuring element is configured to measure the optical density of the fluid based on the optical reflectivity or refractivity of the transparent interface of the second measuring element to the flowing liquid.

6. The measuring device according to claim 5, wherein the aforementioned second measuring element comprises a light source for emitting a light beam, a light guide for the light beam including the aforementioned transparent interface on which the emitted light beam impinges at an acute angle, a light sensor capturing a reflection or refraction of the light beam occurring at the transparent interface, and a detector circuit for the light sensor for detecting the optical reflectivity or refractivity of the transparent interface.

7. The measuring device according to claim 6, wherein the aforementioned interface of the first measuring element is thermally conducting, and the aforementioned first measuring element is configured to calorimetrically measure the flow velocity of the fluid based on the heat transmission between the thermally conducting interface of the first measuring element and the flowing fluid, wherein the aforementioned first measuring element comprises a first temperature sensor for the temperature of the fluid, and a second temperature sensor that is heated by a regulating circuit to a constant temperature difference compared to the temperature of the fluid and that includes the aforementioned thermally conducting interface, the heating power supplied to the second temperature sensor by the regulating circuit being a measure of the flow velocity, and wherein the evaluation unit is arranged in a housing, and in that the first and second temperature sensors, the light source, the light guide and the light sensor are arranged in a measuring probe that is separate from the housing.

8. The measuring device according to claim 7, wherein furthermore the regulating circuit and the detector circuit are arranged in the housing.

9. A measuring probe, in particular for a measuring device according to claim 1, comprising:
a carrier;
for measuring the flow velocity of the fluid, a first measuring transmitter, which is anchored at the carrier and includes an interface;
for measuring a characteristic property of the fluid, a second measuring transmitter, which is anchored at the carrier and includes an interface; and
an electrical connection to which the two measuring transmitters are connected, the aforementioned interfaces of the first and second measuring transmitters being provided on an outer side of the measuring probe for immersion into a flowing fluid.

10. The measuring probe according to claim 9, wherein the aforementioned first measuring transmitter comprises a first temperature sensor and a second temperature sensor including the aforementioned interface of the first measuring transmitter being thermally conducting.

11. The measuring probe according to claim 9, wherein the aforementioned second measuring transmitter comprises a light source for emitting a light beam, a light guide for the light beam including the aforementioned interface on which the emitted light beam impinges at an acute angle, and a light sensor capturing a reflection or refraction of the light beam occurring at the interface, the aforementioned interface of the second measuring transmitter being transparent.

12. The measuring probe according to claim 11, wherein the light source is anchored at a first side of the carrier, and the light sensor is anchored at a second side of the carrier facing away from the first side, and wherein the light guide extends from the first to the second side.

13. The measuring probe according to claim 12, wherein the light guide has the shape of a prism with three or more lateral surfaces, one lateral surface of which prism facing the light source and the light sensor, and at least one of the other lateral surfaces of which prism forming the aforementioned transparent interface.

14. The measuring probe according to claim 11, wherein the light guide is made of silicone.

15. The measuring probe according to claim 9, wherein the carrier is a flexible printed circuit board.
